(19) United States
(12) Patent Application Publication
(10) Pub. No.: US 2003/0110572 A1
(43) Pub. Date: Jun. 19, 2003

(54) Multi-purpose opener

(76) Inventor: Dupre Percival, Irmo, SC (US)

Correspondence Address: SARA A. CENTIONI, NEXSEN PRUET JACOBS & POLLARD, LLC, PO DRWR 2426, COLUMBIA, SC, 29202-2426, US

(21) Appl. No.: 10/320,233

(22) Filed: Dec. 16, 2002

Related U.S. Application Data
(60) Provisional application No. 60/341,116, filed on Dec. 14, 2001.

(51) Int. Cl. B67B 7/00

(52) U.S. Cl. 7/151

(57) ABSTRACT

A multi-purpose opener made of a bent, rigid member. At one end of the opener, a blade is formed for the opening of such things as shellfish and envelopes. The opener is dimensioned to conveniently fit within the palm of the hand of user providing a firm grasp during the opening. At the other end of the opener is a bar spaced apart from the end of the rigid member. The bar, which is used to remove a beverage cap, is dimensioned to fit beneath the edge of the cap.

### CROSS REFERENCE TO RELATED APPLICATIONS:

This application claims priority to Provisional Application Serial No. 60/341,116 filed Dec. 14, 2001.

### STATEMENT REGARDING FEDERALLY SPONSORED RESEARCH OR DEVELOPMENT

Not applicable.

### REFERENCE TO A SEQUENCE LISTING, A TABLE, OR A COMPUTER PROGRAM LISTING COMPACT DISK APPENDIX

Not Applicable.

### BACKGROUND OF THE INVENTION

The present invention relates generally to hand tools and more specifically tools for use in opening a closed or sealed workpiece.

Levers are basic machines that use mechanical advantage to multiply force. Levers have two ends, one end for application of the force and the other end for the load; a fulcrum is provided between the two ends but closer to the load and provides a strong point about which the lever is pivoted.

In an alternate arrangement, the fulcrum can be placed at one end and the load near it but on the same side of the lever as the lifting end. The force pivots the load about the fulcrum. The type of lever and its precise method of use can be governed by the object or workpiece it is operated on. These workpieces may be lifted or may be pried open using levers. The lever's geometry and mode of use will determine its mechanical advantage, that is, the degree to which they multiply the force of the user. Although some prying devices can be used for a number of different purposes, it is often better to have a prying device designed for the specific application in mind.

Among the objects that are pried open are oysters and bottles. Typically, the type of prying device that is used to open an oyster, and which is called a shucker, is generally a knife with a flat, strong, symmetric blade. Oyster shuckers are generally used by inserting the tip of the blade between the oyster shells and then twisting the handle to leverage the shells open. For bottle openers, a bottle typical opener pries one side of the bottle's crown cap up using the opposing edge of the bottle opener as a fulcrum.

Multifunction tools are well known. Perhaps the most famous type of such a tool is a “Swiss Army” knife, which may include an assortment of devices for use in the out-of-doors. In dining utensils, combining functions of different tools into one multi-purpose tool is contrary to practice. In fact, in formal dining, diners may be bewildered by the array of different utensils provided for the various courses of the dinner.

### SUMMARY OF THE INVENTION

According to its major aspects and briefly recited, the present invention is a multifunction prying tool that is specifically designed to pry open oysters with one end and crown caps from beverage bottles with the opposing end. The present tool is simply designed, being made of a rod of strong material looped back on itself at a first end and flattened at the opposing, second end. The looped first end has a cross piece to allow that end to function as a cap-prying device. The flattened second end is shaped to pry open oysters. The plane of the second end lies at an angle to the plane of the first end for the comfort of the user.

An important feature of the present invention is that it can be made almost entirely of a single rod of strong material, such as steel. This feature simplifies construction and reduces cost to manufacture the present device. Only the cross piece that joins to the sides of the loop must be added.

Another important feature of the present invention is the loop at the first end. This loop has two functions. First, it gives the user more leverage in twisting the second end when prying open oysters. Second, it is part of the cap-removing end, being used as the fulcrum and as the part of the tool to which the cross piece is anchored.

Still another important feature of the present invention is the flattened, angled second end. This end is flattened to allow it to be inserted between the shells of an oyster and angled to allow the wrist and hand to be held in a more comfortable position.

These and other features and their advantages will become apparent to those skilled in the art of multi-function tool design from a careful reading of the Detailed Description of Preferred Embodiments, accompanied by the following drawings.

### BRIEF DESCRIPTION OF THE DRAWINGS

In the drawings,

FIG. 1 is a perspective view of a device according to a preferred embodiment of the present invention;

FIG. 2 is a top view of the device of FIG. 1;

FIG. 3 is a bottom view of the device of FIG. 1;

FIG. 4 is a right side view of the device of FIG. 1;

FIG. 5 is a left side view of the device of FIG. 1;

FIG. 6 is a bottom view of the device of FIG. 1;

FIG. 7 is a top view of the device of FIG. 1;

FIG. 8 is a perspective view of the device of FIG. 1 shown in use shucking an oyster, with the oyster and the hand of the user shown in phantom lines; and

FIG. 9 is a perspective view of the device of FIG. 1 shown in use opening a beverage bottle, with the bottle and the hand of the user shown in phantom lines.

### DETAILED DESCRIPTION OF PREFERRED EMBODIMENTS

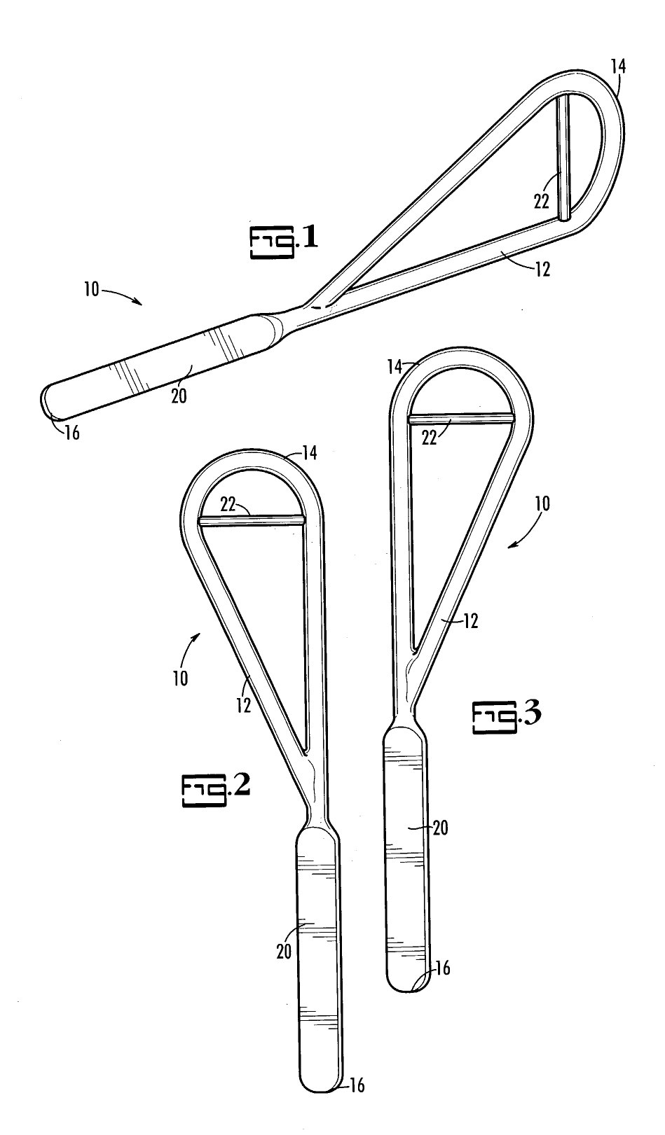

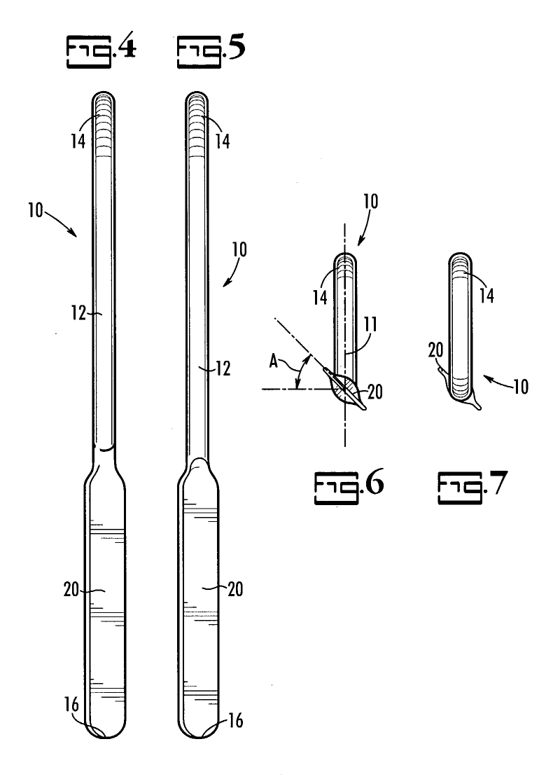

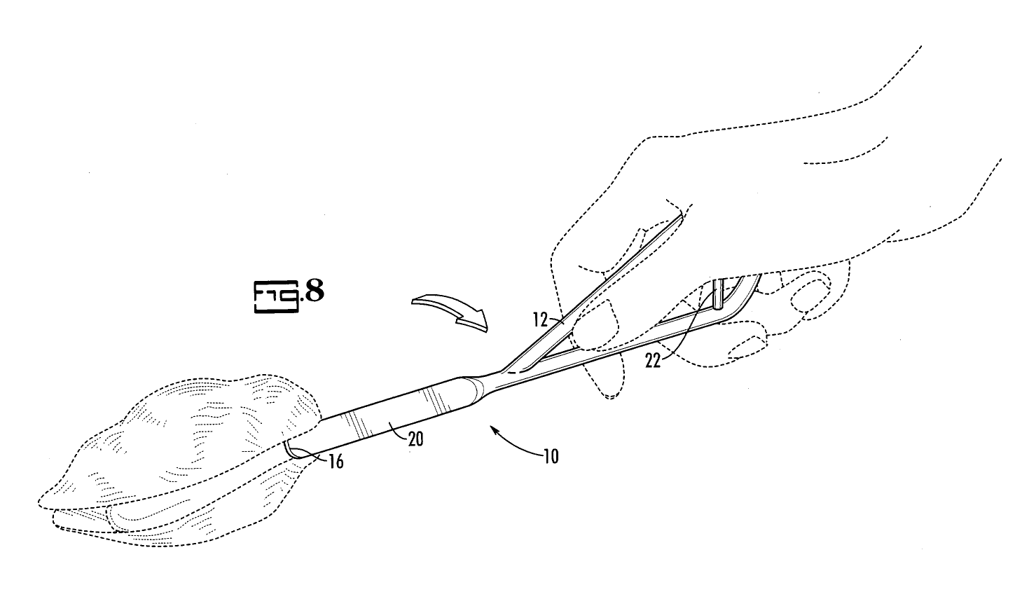

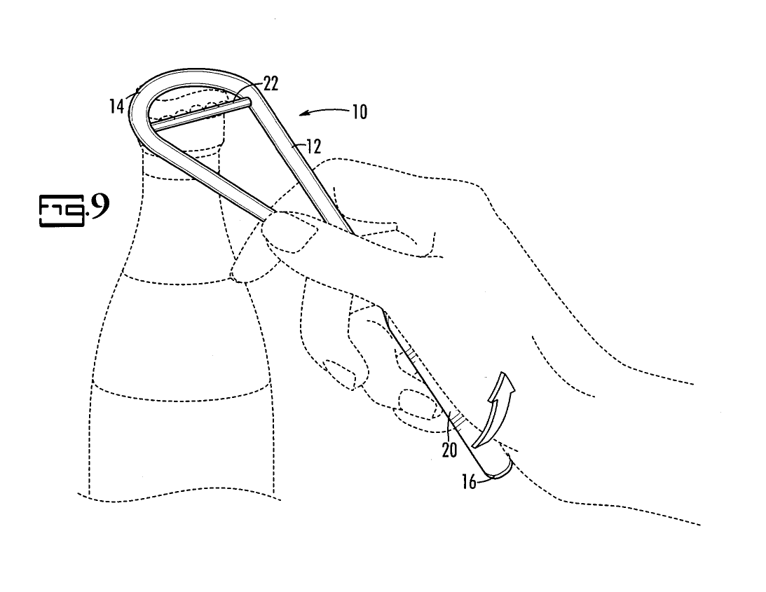

Referring now to the drawings, there is shown a multi-purpose opener 10 in FIG. 1. FIGS. 2-7 show different perspectives of opener 10. As shown, opener 10 includes a rod 12 of generally pear- or somewhat oval-shape having a first end 14 and an opposing second end 16, each of which is used for a different opening purpose. Rod 12 is formed to define a loop at first end 14. Further included at first end 14 is a brace 22, which crosses the loop defined by rod 12. Preferably, brace 22 defines a space that is dimensioned to receive a portion of a beverage cap, such as a crown cap. Therefore, first end 14 of opener can be used for the opening of beverages.

At second end 16, rod 12 is formed to define a blade 20. Blade 20 is used for the opening of such things as shellfish and envelopes. Preferably, blade 20 is angled with respect to the loop of rod 12. As shown in FIG. 6, looped first end 14 of rod 12 defines a plane 11. Blade 20 of opener is at an angle A with plane 11. Preferably, angle A is approximately 45 degrees so as to accommodate both left- and right-handed users and to increase the ease of opening. Although blade 20 can be used to open shellfish, such as oysters, it can also be used to open envelopes. One wishing to shuck an oyster simply holds the shellfish with one hand, grips opener 10 with the other, and then proceeds to pry open the shell with blade 20 of opener 10. Similarly, one wanting to open a letter simply slides blade 20 along the edge of the envelope. The shape of opener 10 is dimensioned to conveniently fit within the palm of a hand thereby optimizing both comfort and strength of the user during the opening of both shellfish and letters.

As previously described, another use for opener is to open beverages, such as those having crown caps. As shown in FIG. 9, not only does brace 22 define a space dimensioned to receive a portion of a beverage cap, but brace 22 itself is dimensioned to fit beneath the end of the beverage cap. By placing the edge of brace 22 beneath a beverage cap and upwardly applying pressure thereto using the outer surface of rod 12 as a fulcrum placed on top of the cap, a user may conveniently pry open a beverage bottle while holding opener 10 just above blade 20. Optionally, the edge of brace 22 may be beveled for easier insertion beneath the beverage cap.

The present opener may be made of any rigid material, but preferably made of steel or aluminum, most preferably of polished stainless steel. Also, preferably it is made of a single rod of steel bent back to intersect itself where it may be welded to itself.

A feature of the present invention is the simplicity and ease of manufacturing of opener 12. A method of making opener 10 includes the following steps: 1) providing rod 12 have first end 14 and second end 16; 2) looping rod 12 back upon itself so that rod 12 defines a loop at first end 14; 3) providing brace 22 to cross the loop; 4) flattening second end 16 of rod 12; and angling second end 16 with respect to the loop.

Those skilled in the art of utensils will understand that many substitutions and modifications can be made to the preferred embodiment described above without departing from the spirit and scope of the present invention, defined by the appended claims.

What is claimed is:

1. A multi-function prying device, comprising:
a rod having a first end and a second end, wherein said rod is formed to define a loop at said first end, and wherein said rod is formed to define a blade at said second end; and
a brace crossing said loop.

2. The device as recited in claim 1, wherein said first end defines a plane, and wherein said second end lies at an angle to said plane.

3. The device as recited in claim 2, wherein said angle is approximately 45 degrees.

4. The device as recited in claim 1, wherein said loop is dimensioned to fit within the palm of a hand.

5. The device as recited in claim 1, wherein said rod is made of steel.

6. The device as recited in claim 1, wherein said brace defines a space that is dimensioned to receive a portion of a beverage cap.

7. The device as recited in claim 1, wherein said first end has a rubberized coating.

8. A method for making a multi-function prying device, comprising:
providing a rod having a first end and a second end;
looping said first end back upon said rod, wherein said first end defines a loop;
providing a brace to cross said loop;
flattening said second end; and
angling said second end.

9. The method as recited in claim 8, wherein said loop defines a plane, and wherein said angling step results in an angle of approximately 45 degrees between said flattened second end and said plane.

10. The method as recited in claim 8, wherein said looped first end is dimensioned to fit within the palm of a hand.

11. The method as recited in claim 8, wherein said brace in cooperation with said loop defines a space that is dimensioned to receive a portion of a beverage cap.
